(19) United States
(12) Patent Application Publication
(10) Pub. No.: US 2023/0080931 A1
(43) Pub. Date: Mar. 16, 2023

(54) TURBINE STAGE SEALING MECHANISM

(71) Applicant: TOSHIBA ENERGY SYSTEMS & SOLUTIONS CORPORATION, Kawasaki-shi (JP)

(72) Inventors: Shogo IWAI, Tokyo (JP); Takahiro ONO, Tokyo (JP); Yoshifumi IWASAKI, Tokyo (JP)

(73) Assignee: TOSHIBA ENERGY SYSTEMS & SOLUTIONS CORPORATION, Kawasaki-shi (JP)

(21) Appl. No.: 17/832,193

(22) Filed: Jun. 3, 2022

(30) Foreign Application Priority Data
Sep. 15, 2021 (JP) 2021-150117

(51) Int. Cl. F01D 11/08

(52) U.S. Cl. CPC F01D 11/08; F05D 2220/32; F05D 2240/55

(57) ABSTRACT

According to an embodiment, a turbine stage sealing mechanism reduces leak flow, which bypasses a working fluid flow path, between a rotating part and a stationary part in each turbine stage of a gas turbine. A radially inner side end portion of the stationary part is formed to be on a circle centered at a center axis of the rotating part under a predetermined operating condition of the gas turbine.

### CROSS-REFERENCE TO RELATED APPLICATION

This application is based upon and claims the benefit of priority from Japanese Patent Application No. 2021-150117 filed on Sep. 15, 2021, the entire content of which is incorporated herein by reference.

### FIELD

Embodiments of the present invention relate to a turbine stage sealing mechanism of a gas turbine.

### BACKGROUND

It is important to design gas turbines in recent years especially from the thermal viewpoint because of higher temperature of a working fluid. Specifically, the gas turbines need to have a thin structure. For this end, some structure parts are configured to be cooled by a cooling medium, for example, with a hollow cooling structure or the like.

In the case of a supercritical CO₂ turbine among the gas turbines, its operating pressure is higher at the same level as that of a steam turbine, and a pressure difference occurring in its rotor blade and stator blade, namely, a pressure difference between the cooling medium and the working fluid or a pressure difference between before and after the rotor blade is larger than that of the conventional gas turbine. Therefore, a rigid structure is necessary for suppressing the pressure deformation caused by the large pressure difference.

As explained above, in the supercritical CO₂ turbine, a stator blade which is high in rigidity and has a cooling structure and a shroud which is provided on the radially outer side of the rotor blade are used under conditions that the temperature gradient and the thermal deformation are larger than those in the conventional gas turbine.

In a turbine stage, a plurality of stator blades are provided adjacent to each other in the circumferential direction to form a stator blade cascade. Further, a plurality of rotor discs each radially projecting in a disk shape from the rotor shaft are formed with intervals from each other in a direction parallel to the rotation axis of the rotor shaft (hereinafter, called a turbine axis direction). In each of the rotor discs, a plurality of rotor blades are implanted adjacent to each other in the circumferential direction to form a rotor blade cascade. Note that the rotor blades are not limited to this, but are carved out of, for example, a material with a large diameter so that the rotor shaft and the rotor blades are integrally formed in some cases.

A plurality of the stator blade cascades and a plurality of the rotor blade cascades are alternately provided in the turbine axis direction, and each of the stator blade cascades and a rotor blade cascade immediately downstream thereof in the flow direction of the working fluid constitute a turbine stage.

A sealing mechanism of the turbine stage has a part that is provided on the radially outer side of the rotor blade cascades and a part that is provided in the radially inner side of the stator blade cascades.

First, as for the part on the radially outer side of the rotor blade cascade, a shroud as the sealing mechanism of the turbine stage is provided in the circumferential direction in a manner to surround the rotor blade in the circumferential direction via a gap between itself and the rotor blade, to suppress a leak flow bypassing a working fluid flow path of the working fluid. The shroud has a plurality of shroud segments arranged adjacent to each other in the circumferential direction.

FIG. 8 is a perspective view illustrating a thermal deformation of the shroud segment. FIG. 8 illustrates only a half in the circumferential direction of one shroud segment. More specifically, there is actually a portion existing on the opposite side (left side in FIG. 8) which is plane symmetrically with respect to a virtual cross section S across the virtual cross section S, but this portion is omitted for convenience of illustration in FIG. 8.

Radially inner side of the shroud segment becomes higher in temperature due to a leak flow of a working fluid flowing between itself and a rotor blade (not illustrated) provided on the radially inner side of the shroud segment. On the other hand, radially outer side of the shroud segment is cooled by a cooling medium flowing on the outer surface of the shroud segment, and becomes lower in temperature than the radially inner side.

Therefore, a temperature distribution occurs in the radial direction in the shroud segment, so that the thermal expansion in the circumferential direction and the turbine axis direction on the radially inner part is larger than the thermal expansion on the radially outer part. As a result, the shroud segment bends back radially outward due to thermal expansion difference between the radially inner and outer parts regarding the circumferential direction and the turbine axis direction, namely, the shroud segment deforms to become convex to the radially inner side as illustrated by arrows in FIG. 8.

Next, on the radially inner part of the stator blade cascade, an inner ring sidewall as a turbine stage sealing mechanism is provided in a manner to face a rotating part.

The radially outer side of the inner ring sidewall is a main flow path of the working fluid at high temperature, and the radially inner side allows the cooling medium from the rotating part facing thereto to flow in some cases, so that the temperature on the radially outer side is higher than the temperature on the radially inner side in some cases. Besides, because of the complexity of the configuration, there is a case opposite to the above. In other words, there are a case where the inner ring sidewall deforms in the same direction as that of an outer ring sidewall and a case where the inner ring sidewall deforms in the opposite direction, depending on the temperature distribution of the stator blade and the rigidity of each portion in the stator blade.

Especially, in the case of the deformation of bending back radially outward regarding the circumferential direction, a gap between the shroud segment and the rotor blade becomes no longer uniform state in the circumferential direction, and a portion with a large gap and a portion with a small gap are alternately formed in the circumferential direction. The gap between the inner ring sidewall of the stator blade and the rotating part arranged on the radially inner side is also similar.

In the case where the gap varies in the circumferential direction in the sealing mechanism of the turbine stage as explained above, it is necessary to perform designing and manufacture in conformity with a portion where the gap is smallest in order to avoid contact between the stationary part and the rotating part. As a result of this, there is a portion having a gap larger than a proper value, causing a problem of a deterioration in turbine performance.

### BRIEF DESCRIPTION OF THE DRAWINGS

FIG. 1 is a partial longitudinal sectional view along a turbine axis illustrating a part of a gas turbine including a turbine stage sealing mechanism according to an embodiment;

FIG. 2 is a longitudinal sectional view illustrating details of a shroud segment as the turbine stage sealing mechanism according to the embodiment and its periphery;

FIG. 3 is a partial sectional view in an assembled state illustrating details of the shroud segment as the turbine stage sealing mechanism according to the embodiment in a view taken along line arrow III-III in FIG. 2;

FIG. 4 is a flowchart illustrating the procedure of a method of manufacturing the turbine stage sealing mechanism;

FIG. 5 is a graph conceptually illustrating the change in temperature of a working fluid at each stage during start-up of the gas turbine;

FIG. 6 is a graph conceptually illustrating the change in pressure of the working fluid at each stage during start-up of the gas turbine;

FIG. 7 is a partial sectional view of the shroud segment for explaining machining contents in the method of manufacturing the turbine stage sealing mechanism; and

FIG. 8 is a perspective view illustrating a thermal deformation of the shroud segment as the turbine stage sealing mechanism.

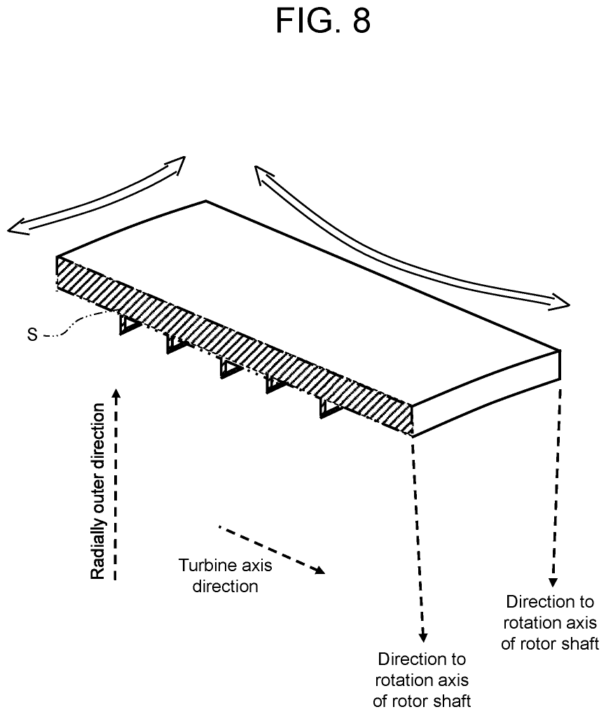

### DETAILED DESCRIPTION

An object of embodiments of the present invention is to reduce deterioration in performance of a sealing mechanism of a turbine stage due to thermal deformation.

To achieve the above object, there is provided a turbine stage sealing mechanism for reducing leak flow between a rotating part and a stationary part, the leak flow bypassing a working fluid flow path, in each turbine stage of a gas turbine, wherein a radially inner side end portion of the stationary part is formed to be on a circle centered at a center axis of the rotating part under a predetermined operating condition of the gas turbine.

Hereinafter, a turbine stage sealing mechanism according to the embodiments of the present invention will be explained with reference to the drawings. Here, common codes are given to mutually same or similar portions to omit duplicate explanations.

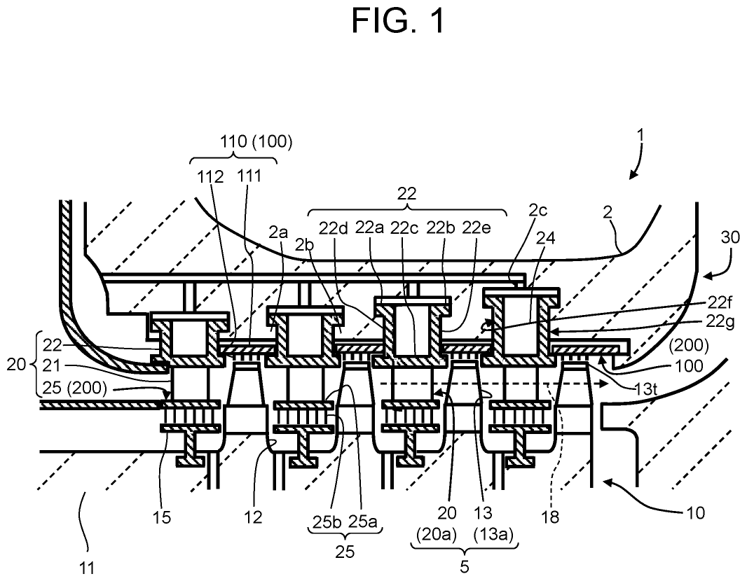

FIG. 1 is a partial longitudinal sectional view along a turbine axis CL0 illustrating a part of a gas turbine 1 including a turbine stage sealing mechanism 200 according to the embodiment. Hereinafter, a direction parallel to the turbine axis CL0 is called a turbine axis direction.

The gas turbine 1 has a casing 2, a rotor shaft 11 penetrating the casing 2 in the turbine axis direction, and a plurality of turbine stages 5 which are arrayed in the turbine axis direction to form a flow path of a working fluid.

Each of the plurality of turbine stages 5 has a stator blade cascade 20a having a plurality of stator blades 20, and a rotor blade cascade 13a arranged immediately after the stator blade cascade 20a in a flow direction of the working fluid in a working fluid flow path 18 and having a plurality of rotor blades 13.

The plurality of stator blades 20 constituting the stator blade cascade 20a are provided adjacent to each other in the circumferential direction. Each of the stator blades 20 has a blade effective part 21 arranged in the working fluid flow path 18, an outer ring sidewall 22 connected to a radially outer side end portion of the blade effective part 21, and an inner ring sidewall 25 connected, as a turbine stage sealing mechanism 200, to a radially inner side end portion of the blade effective part 21. Therefore, the turbine stage sealing mechanism 200 includes the inner ring sidewall 25.

The outer ring sidewall 22 is formed with a front wall portion 22d and a back wall portion 22e each of which extends from a plate-shaped portion 22c to the radially outer side. A front hook 22a is formed in a manner to extend forward from a radially outer side end portion of the front wall portion 22d. Further, a rear hook 22b is formed in a manner to extend rearward from a radially outer side end portion of the back wall portion 22e. On the other hand, the casing 2 is also formed with a first hook 2a and a second hook 2b. The front hook 22a and the rear hook 22b of the outer ring sidewall 22 engage with the first hook 2a and the second hook 2b of the casing 2 respectively, whereby the stator blade 20 is supported by the casing 2.

The plurality of outer ring sidewalls 22 are formed with respective cooling medium spaces 24 which communicate with each other in the circumferential direction. The casing 2 is formed with a cooling hole 2c which communicates with a not-illustrated supply source of a cooling medium, so that the cooling medium is supplied to the cooling medium space 24 to cool the stator blade 20.

Note that the front hook 22a, the front wall portion 22d, and the plate-shaped portion 22c form a recessed portion 22f which extends in the circumferential direction. Further, the rear hook 22b, the back wall portion 22e, the plate-shaped portion 22c form a recessed portion 22g.

The inner ring sidewall 25 is supported by the blade effective part 21 and arranged to face a heat shield plate 15 which is a part of a later-explained rotating part 10. The inner ring sidewall 25 has a plate-shaped portion 25a which expands in the turbine axis direction (the flow direction of the working fluid) and the circumferential direction, and a plurality of seal fins 25b which are formed on a radially inner side surface of the plate-shaped portion 25a and arranged at intervals from each other in the turbine axis direction. The inner ring sidewall 25 suppresses, as the turbine stage sealing mechanism 200, a leak flow of the working fluid flowing while bypassing the working fluid flow path 18 to the radially inner side, together with the heat shield plate 15.

The rotor shaft 11 is formed with a plurality of rotor discs 12 at intervals from each other in the turbine axis direction. Each of the rotor discs 12 is formed in a manner to project in a disk shape from the rotor shaft 11 to the radially outer side. The plurality of rotor blades 13 constituting the rotor blade cascade 13a are implanted adjacent to each other in the circumferential direction in each of the rotor discs 12. Hereinafter, the rotor shaft 11, the rotor discs 12, the rotor blades 13, and a portion which is attached to the rotor shaft and rotates with the rotor shaft 11 are called the rotating part 10. Note that though a case where the rotor blades 13 are implanted is illustrated herein, the following also applies to a case where the rotor shaft and the rotor blades are integrally formed by carving out the rotor blades.

On the radially outer side of the rotor blade cascade 13a, a shroud 100 is provided via a gap between itself and rotor blade tip portions 13t. The shroud 100 has a plurality of shroud segments 110 arranged adjacent to each other in the circumferential direction. Each of the shroud segments 110 is arranged between the outer ring sidewalls 22 adjacent to each other in the turbine axis direction so that its upstream tip portion and its downstream tip portion are housed in the recessed portion 22g which is formed in the outer ring sidewall 22 on the upstream side and in the recessed portion 22f which is formed in the outer ring sidewall 22 on the downstream side, respectively. Further, during operation of the gas turbine 1, the shroud 100 is pressed against the downstream side stator blades 20 by a differential pressure before and after the working fluid.

Each of the shroud segments 110 has a plate-shaped portion 111 arranged in the circumferential direction at a predetermined radial gap from a radially outermost portion of the rotating part 10 of the gas turbine 1, and a plurality of seal fins 112 which are formed on the radially inner side surface of the plate-shaped portions 111 and arranged at predetermined intervals in the turbine axis direction. The shroud 100, as the turbine stage sealing mechanism 200, bypasses the working fluid flow path 18 to the radially outer side and suppress the leak flow of the working fluid flowing between itself and the rotor blade tip portions 13t. Therefore, the turbine stage sealing mechanism 200 includes the shroud 100.

Note that the casing 2, parts maintaining a stationary state such as the stator blades 20 and the shroud 100 are collectively called a stationary part 30.

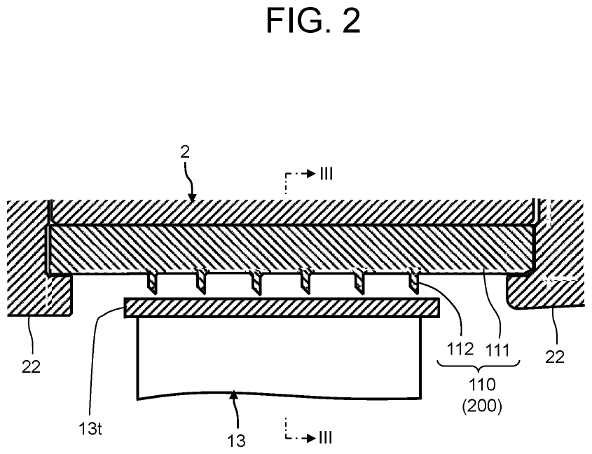

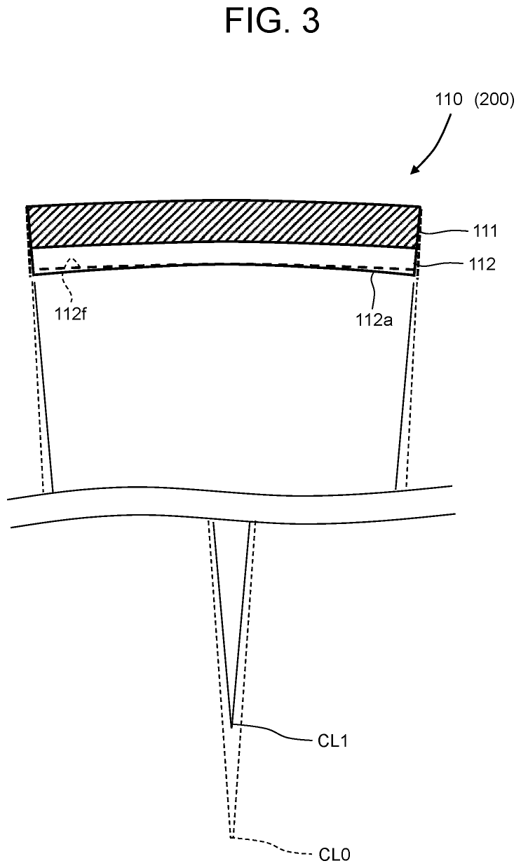

FIG. 2 is a longitudinal sectional view illustrating details of the shroud segment 110 as the turbine stage sealing mechanism 200 according to the embodiment and its periphery. Further, FIG. 3 is a partial sectional view in an assembled state illustrating details of the shroud segment as the turbine stage sealing mechanism according to the embodiment in a view taken along line arrow III-III in FIG. 2. Note that FIG. 3 is the view taken along line arrow III-III in FIG. 2 but indicates only the shroud segment 110 as the turbine stage sealing mechanism 200 and omits the illustration of the other portions illustrated in FIG. 2.

As illustrated in FIG. 2, on the radially inner side of the plate-shaped portion 111 of the shroud segment 110, the plurality of seal fins 112 are formed in a manner to extend from the inner side surface toward radially inner side. In other words, the plurality of seal fins 112 are on a radially innermost portion of the stationary part 30 facing the rotor blade 13 of the rotating part 10. The plurality of seal fins 112 are arranged with predetermined intervals in the turbine axis direction. Each of the plurality of seal fins 112 extends in the circumferential direction. Note that as the seal fin 112 including the one in the fin shape as illustrated in FIG. 2 or the one having a rectangular cross section vertical to the circumferential direction are collectively called the seal fin 112. As a result, a labyrinth is formed between the radially inner side of the shroud segment 110 and the rotor blade tip portion 13t.

As illustrated in FIG. 3, the radially outer side surface of the shroud segment 110 is in an arc shape centered at the turbine axis CL0 in the cross section vertical to the turbine axis direction. On the other hand, a radially inner side end portion 112a of the seal fin 112 has a shape which does not coincide with a virtual inner side end portion 112f in an arc shape centered at the turbine axis CL0 at room temperature. Specifically, the inner side end portion 112a of the seal fin 112 is formed to be in an arc shape centered at the turbine axis CL0 as a result of a thermal deformation of the shroud segment 110 under a predetermined operating condition at start-up of the gas turbine 1.

For the purpose of forming the radially inner side end portion 112a of the seal fin 112 in the above-described arc shape centered at the turbine axis CL0 under the predetermined operating condition at start-up of the gas turbine 1, the radially inner side end portion 112a of the seal fin 112 is formed as follows at room temperature. That is, the radially inner side end portion 112a of the seal fin 112 is formed to be closer to the turbine axis CL0 in the assembled state toward the circumferential end portion from the circumferential center. Alternatively, when the radially inner side surface of the plate-shaped portion 111 of the shroud segment 110 is an arc shape centered at the turbine axis CL0 in the assembled state in the cross section vertical to the turbine axis, the inner side end portion 112a of the seal fin 112 is formed so that the height in the radial direction of the seal fin 112, namely, the length from the radially inner side surface of the plate-shaped portion 111 to the inner side end portion 112a is increased.

Note that the case where only the radially inner side end portion 112a of the seal fin 112 is formed to be in an arc shape centered at turbine axis CL0 under the predetermined operating condition is explained as an example in FIG. 3, but not limited to this. In other words, also for the plate-shaped portion 111 of the shroud segment 110, the radially inner side surface, or the radially inner side surface and the radially outer surface may be formed similar to the radially inner side end portion 112a of the seal fin 112.

Such a shape that the radially innermost portion of the stationary part 30 is on a circle centered at the center axis CL0 of the rotor shaft 11 under the predetermined operating condition, namely, coincides with a part or the whole of the circle as above can be decided by thermal deformation analysis of the shroud segment 110. Alternatively, as an approximate but substantially accurate and simple method, the shape of the radially inner side end portion 112a of the seal fin 112 may be made into an arc having a radius of curvature smaller than that of the arc of the virtual inner side end portion 112f and having, as its center, a center CL1 eccentric to the shroud segment 110 side from the turbine axis CL0. The position of the center CL1 in this case may be decided based on the thermal deformation analysis of the shroud segment 110. Similarly, also for the inner ring sidewall 25, an appropriate shape can be decided depending on the temperature distribution of the stator blade 20 in the operating state of the gas turbine 1 and the result of the deformation analysis based on a load applied to the stator blade 20 by the working fluid.

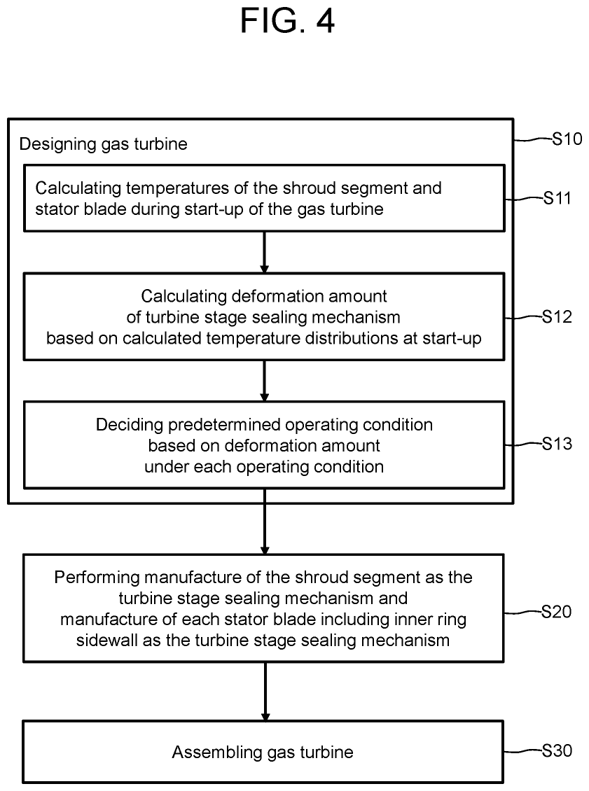

FIG. 4 is a flowchart illustrating the procedure of a method of manufacturing the turbine stage sealing mechanism. The method of manufacturing the turbine stage sealing mechanism has a gas turbine designing step S10, a gas turbine manufacturing step S20 and gas turbine assembling step S30.

First, the gas turbine designing step S10 will be explained. Note that only portions relating to the features of this embodiment will be explained, and explanation of designing contents of an ordinary gas turbine will be omitted in the following.

The temperatures of the shroud segment 110 and the stator blade 20 during start-up of the gas turbine 1 are calculated (Step S11). More specifically, the temperature distribution at each of the shroud segment 110 as the turbine stage sealing mechanism 200 and the stator blade 20 including the inner ring sidewall 25 as the turbine stage sealing mechanism 200 at each time point after the ignition of the gas turbine 1 to the rated operation is calculated. Note that the temperature at each of main operating states such as each load arrival time or continuous temperature change during start up process may be obtained as the temperature distribution at each time point.

In this step S11 and the next step S12, the shape of each of the inner side end portion 112a of the seal fin 112 of the shroud segment 110 and the radially inner side end portion of the seal fin 25b of the inner ring sidewall 25 is assumed to be in an arc shape centered at the turbine axis CL0 in the cross section vertical to the turbine axis direction.

Next, the deformation amount of the turbine stage sealing mechanism is calculated based on the calculated temperature distributions at start-up (Step S12). Here, especially for the inner ring sidewall 25 which is one part of the turbine stage sealing mechanism 200, the deformation amount of the inner ring sidewall 25 needs to be obtained as a part of the whole stator blade 20 since the rigidity of the outer ring sidewall 22 is high in the stator blade 20 as explained above.

As a result of them, a deviation amount from an arc-shaped curve centered at the turbine axis CL0 is obtained with respect to each of the shapes of the curves of the inner side end portion 112a of the seal fin 112 of the shroud segment 110 and the radially inner side end portion of the seal fin 25b of the inner ring sidewall 25 in the cross section vertical to the turbine axis direction.

First, a predetermined operating condition is decided based on the deformation amount under each operating condition (Step S13). More specifically, in setting the shapes of the inner side end portion 112a of the seal fin 112 of the shroud segment 110 and the radially inner side end portion of the seal fin 25b of the inner ring sidewall 25, it is determined at which time point in the start-up process the deformation amount of the state is based on.

Here, a method for deciding the operating condition for setting the deformation amounts of the inner side end portion 112a of the seal fin 112 and the radially inner side end portion of the seal fin 25b of the inner ring sidewall 25 will be explained. For this, the changes in temperature and pressure at each stage will be explained first as the operating conditions of the gas turbine 1 after the ignition to the rated operation during start-up of the gas turbine 1.

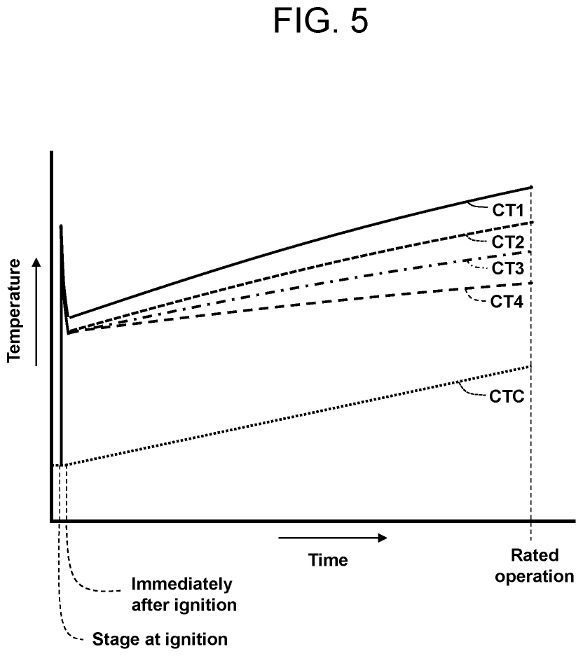

FIG. 5 is a graph conceptually illustrating the change in temperature of the working fluid at each stage during start-up of the gas turbine. The horizontal axis represents time and corresponds to the operating state at start-up. Besides, the vertical axis represents temperature at a stage facing the working fluid flow path 18. Specifically, curves CT1, CT2, CT3 and CT4 indicate the temperatures at the first stage, the second stage, the third stage and the fourth stage which is the final stage, respectively. Further, a curve CTC indicates the temperature of a cooling medium.

The temperatures at the stages during the rated operation are higher in order from the fourth stage which is the final stage, the third stage, the second stage, and the first stage. Besides, the dimension and material differ depending on the stage. Accordingly, the decision of the deformation amounts of the inner side end portion 112a of the seal fin 112 and the radially inner side end portion of the seal fin 25b of the inner ring sidewall 25 at each stage needs to be performed for each stage.

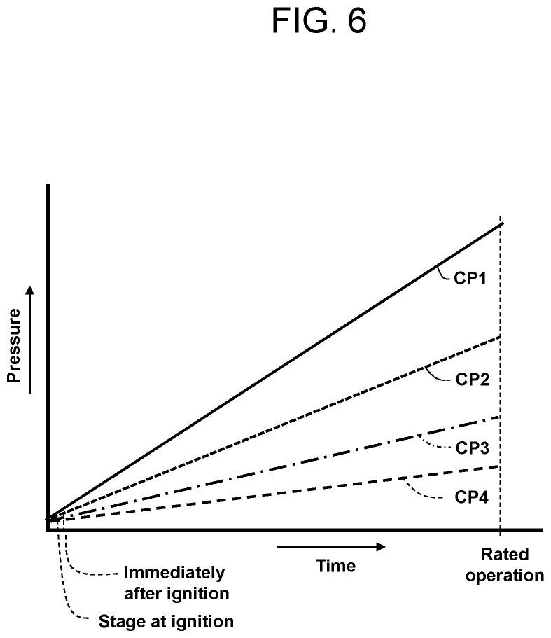

FIG. 6 is a graph conceptually illustrating the change in pressure of the working fluid at each stage during start-up of the gas turbine. The horizontal axis represents time and corresponds to the operating state during start-up. Besides, the vertical axis represents pressure in the working fluid flow path 18. Specifically, curves CP1, CP2, CP3, and CP4 indicate the pressures at the first stage, the second stage, the third stage, and the fourth stage, respectively.

As illustrated in FIG. 6, in a process of warming up, speed up, and load increase of the gas turbine after the ignition, the pressure rises monotonously toward, for example, the pressure at the rated operation for each stage. Note that FIG. 6 illustrates a case where the pressure linearly increases with time as an example, but there is a case where the increase is not linear.

Generally, the whirl phenomenon caused from the excitation force produced by the leakage of the working fluid at the turbine rotor blade tip and the excitation force produced by the pressure fluctuation at a labyrinth seal portion between the turbine stator blade and the rotor shaft is likely to occur with an increase in load. In other words, the operating condition closer to the rated operating condition increases the risk of causing a whirl vibration. The imbalance in circumferential gap width due to the thermal deformation of the turbine stage sealing mechanism 200 is considered to be a possible cause of the whirl vibration.

Accordingly, the imbalance in circumferential gap width due to the thermal deformation of the turbine stage sealing mechanism 200 needs to be eliminated before a high-load state. Therefore, the “predetermined operating condition” is preferably decided from the operating condition during a period immediately after the ignition to a partial load time. In this event, the predetermined operating condition is desirably as close as possible to the rated condition in the partial load time when taking the performance under the rated condition into consideration, but a setting having a margin in consideration of a vibration risk is needed.

Focusing attention again on the temperature change, as illustrated in FIG. 5, the temperature rapidly rises at each stage at the ignition in a combustor (not illustrated). Immediately after the ignition thereafter, the temperature returns to the temperature at a higher level than the temperature before the ignition. In the process of warming up, speed up, and load increase of the gas turbine 1, for example, the temperature rises monotonously toward the temperature at the rated operation in each stage. Note that the temperature of the cooling medium rises after the ignition, and then becomes almost constant in level.

At the initial phase immediately after the ignition, the difference between the temperature of the cooling medium and the temperature at each stage decreases because the temperature of the cooling medium rises. In other words, the radial temperature difference causing the thermal deformation of the turbine stage sealing mechanism 200 decreases. After reaching State S1, the temperature of the cooling medium becomes almost constant, whereas the temperature at each stage rises, resulting in increase in the radial temperature difference causing the thermal deformation of the turbine stage sealing mechanism 200.

On the other hand, the level of the temperature at each stage itself rises immediately after the ignition to a temperature at considerable level as compared with the temperature before the ignition. For example, at the first stage, the temperature rises up to a temperature at an intermediate level between the temperature before the ignition and the temperature at the rated operation. Further, at the second stage, because of a small temperature rise width immediately after the ignition to the rated operation time, the temperature becomes a temperature closer to the rated temperature than to the intermediate temperature between the temperature before the ignition and the temperature during the rated operation. This tendency becomes larger as the stage goes to the third stage and the fourth stage, so that the temperature becomes a temperature further closer to the rated temperature than to the intermediate temperature between the temperature before the ignition and the temperature during the rated operation.

From the above, the “predetermined operating condition” may be decided in a range from immediately after the ignition to reaching State S1. Further, since the temperature difference between the temperature at each stage and the temperature of the cooling medium is closest to the rated condition in State S1 in this range, the operating condition for State S1 may be decided as the “predetermined operating condition”.

Next, the gas turbine manufacturing step S20 and assembling step S30 will be explained. Note that only portions relating to the features of this embodiment will be explained, and explanation of manufacturing and assembling contents of the ordinary gas turbine will be omitted in the following.

First, in the manufacturing the gas turbine 1 of step S20, the manufacture of the shroud segment 110 as the turbine stage sealing mechanism 200 and the manufacture of each stator blade 20 including the inner ring sidewall 25 as the turbine stage sealing mechanism 200 are performed (First half of Step S20).

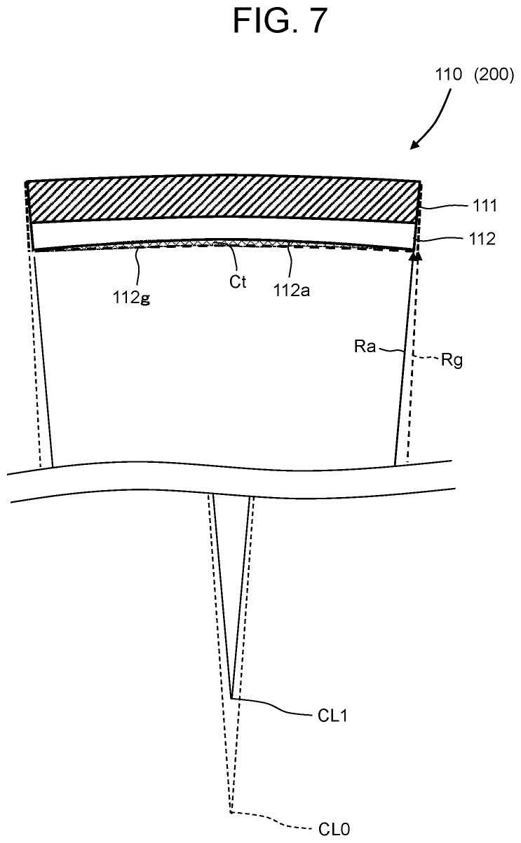

FIG. 7 is a partial sectional view of the shroud segment for explaining the machining contents in the method of manufacturing the turbine stage sealing mechanism. Hereinafter, a case of machining for obtaining the inner side end portion 112a of the seal fin 112 of the shroud segment 110 will be explained as an example, and this explanation also applies to a case of machining the inner side end portion of the seal fin 25b of the inner ring sidewall 25.

At first step of Step S20, as illustrated in FIG. 7, an inner side end portion 112g of the seal fin 112 of the shroud segment 110 is formed in advance to be coaxial with the turbine axis CL0 and have an arc with a radius of curvature Rg when assuming the case of assembling the gas turbine 1, in the cross section vertical to the turbine axis direction.

Next, the radially inner side end portion being the inner side end portion 112a of the seal fin 112 is machined based on the deformation amount in the decided operating condition (latter half of Step S20). More specifically, the inner side end portion 112a of the seal fin 112 of the shroud segment 110 is machined based on the deformation amount in the operating condition decided for each stage, to have a radial shape in an arc coaxial with the turbine axis when it is deformed with the deformation amount.

For example, in the case of forming the inner side end portion 112a by machining the inner side end portion 112g into an arc shape, the arc is made to have, as a center of the arc, the center CL1 closer to the shroud segment 110 than the turbine axis CL0 and have a radius of curvature Ra smaller in value than the radius of curvature Rg. In this event, both circumferential end portions of the inner side end portion 112a coincide with both circumferential end portions of the inner side end portion 112g, or on the radially outer side than them. To secure the radial width of the seal fin, it is preferable that both circumferential end portions of the inner side end portion 112a coincide with both circumferential end portions of the inner side end portion 112g. As a result of this, machining of removing a range of Ct1 illustrated in FIG. 7 is to be performed.

Note that, depending on the conditions, there are cases when the direction in which the shroud segment 110 bends back is not the direction in which it is convex toward the radial center but is the direction in which it is further convex to the radially outer side in some cases. In such cases, the shroud segment 110 on the circumferential end side on the inner surface side is to be machined to the radially outer side. Therefore, a machining margin needs to be provided in advance.

As explained above, in this embodiment, the seal fin 112 on the radially inner surface side of the plate-shaped portion 111 of the shroud segment 110 is formed, and the seal fin 25b on the radially inner surface side of the plate-shaped portion 25a of the inner ring sidewall 25 is formed, as the turbine stage sealing mechanism 200. In the case where the turbine stage sealing mechanism 200 has no seal fin, the machining of the radially inner side end portion of the turbine stage sealing mechanism 200 is the machining of the entire inner surface thereof. On the other hand, in this embodiment, the machining is the machining of the radially inner side end portion of the turbine stage sealing mechanism 200 is the machining of the inner side end portions of the seal fin 112 and the seal fin 25b each composed of an axial thin fin or projection, so that the working load is low and the highly accurate machining can be performed.

In the above-described embodiment, the case where the seal fin 112 is provided on the radially inner surface side of the plate-shaped portion 111 of the shroud segment 110 is provided and thereby forms the labyrinth between itself and the rotor blade tip portion 13t is explained as an example. In short, the case where the radially innermost portion of the stationary part 30 facing the rotor blade 13 of the rotating part 10 is the seal fin 112 is exemplified, but not limited to this. For example, the seal fin may be provided outside the rotor blade tip portion 13t. In this case, since the seal fin is a part of the rotating part 10, the eccentric machining is not performed on the seal fin from the viewpoint of securing the balance during the rotation of the rotating part 10. More specifically, since the shroud segment provided with no seal fin, that is, the plate-shaped portion of the stationary part 30 becomes the radially innermost portion, the eccentric machining is performed on the plate-shaped portion.

As explained above, according to this embodiment, by machining at least the radially inner side end portion of the shroud segment 110 which belongs to the stationary part 30 facing the rotating part 10, the gap with the rotating part 10 becomes circumferentially uniform substantially, namely, in a range of the machining accuracy during operation of the gas turbine 1. As a result of this, it is possible to suppress the deterioration in performance of a sealing mechanism of a turbine stage due to the thermal deformation.

### OTHER EMBODIMENTS

While certain embodiments of the present invention have been described, these embodiments have been presented by way of example only, and are not intended to limit the scope of the inventions. Further, features of the embodiments may be combined.

The embodiments may be embodied in a variety of other forms; furthermore, various omissions, substitutions and changes may be made therein without departing from the spirit of the inventions. The embodiments and modifications are included in the scope and spirit of the inventions and similarly included in the accompanying claims and their equivalents.

What is claimed is:

1. A turbine stage sealing mechanism for reducing leak flow between a rotating part and a stationary part, the leak flow bypassing a working fluid flow path, in each turbine stage of a gas turbine, wherein
a radially inner side end portion of the stationary part is formed to be on a circle centered at a center axis of the rotating part under a predetermined operating condition of the gas turbine.

2. The turbine stage sealing mechanism according to claim 1, the mechanism including a shroud that is a part of the stationary part, wherein:
the rotating part is a rotor blade of the turbine stage; and
the shroud includes shroud segments forming the shroud, wherein each shroud segment is arranged on a radially outer side of the rotor blade.

3. The turbine stage sealing mechanism according to claim 2, wherein
a radially inner side end portion of the shroud segment is formed to be closer to a direction of the center axis of the rotating part in an assembled state toward a circumferential end portion from a circumferential center.

4. The turbine stage sealing mechanism according to claim 2, wherein:
a radius of curvature of the radially inner side end portion of the shroud segment is formed to be smaller than a radius of curvature when a center of curvature coincides with the center axis of the rotating part; and
the center of curvature is eccentric to the shroud segment side from the center axis.

5. The turbine stage sealing mechanism according to claim 1, wherein:
the stationary part includes a stator blade;
the stator blade has an inner ring sidewall; and
the rotating part includes a radially outermost portion of the rotating part facing the inner ring sidewall.
